(19) United States
(12) Patent Application Publication
(10) Pub. No.: US 2006/0113271 A1
(43) Pub. Date: Jun. 1, 2006

(54) Baby bottle apparatus with powder charge to make beverage

(76) Inventor: Donald J. Rea, Chino Valley, AZ (US)

Correspondence Address: TOD R NISSLE, PO BOX 55630, PHOENIX, AZ, 85078, US

(21) Appl. No.: 11/259,967

(22) Filed: Oct. 26, 2005

Related U.S. Application Data
(63) Continuation-in-part of application No. 10/998,480, filed on Nov. 29, 2004.
(60) Provisional application No. 60/673,746, filed on Apr. 21, 2005.

(51) Int. Cl. A61J 11/00; A61J 9/08; A61J 9/00

(52) U.S. Cl. 215/11.6; 215/11.1

(57) ABSTRACT

Apparatus for administering a liquid formulation to a baby or child includes a bottle charged with water, a dispensing valve mounted on the bottle, and a dust cover that extends over and protects the dispensing valve. The dust cover is hollow and is charged with powder that is mixed with water in the bottle to produce the liquid formulation.

This application is a continuation-in-part of Ser. No. 10/998,480 filed Nov. 29, 2004 and claims priority based on provisional application Ser. No. 60/673,746 filed Apr. 21, 2005.

This invention relates to containers for dispensing fluids and other substances.

More particularly, the invention relates to containers for dispensing liquids to be ingesting by babies, young children, or other individuals.

In a further respect, the invention relates to containers for preparing liquids, solids, or other substances to be dispensed for ingestion by an individual.

Baby formulas and other compositions often are provided in a powder form that is admixed with water and then administered to a baby or other individuals. During travel, this is often accomplished by carrying a baby bottle, a bottle of water, and a container of powder. Water and powder are admixed in the bottle to produce formula that is fed to the baby. Carrying the various items mentioned complicates the logistical requirements connected with transporting a baby or young child.

Accordingly, it would by highly desirable to provide an improved method and apparatus for, during transport of a baby, administering a powder-liquid admixture to a baby or young child.

Therefore, it is a principal object of the invention to provide a simplified procedure and apparatus for preparing and administering a powder-liquid mixture to a baby or child.

These and other, further and more specific objects and advantages of the invention will be apparent to those skilled in the art from the following detailed description thereof, taken in conjunction with the drawings, in which:

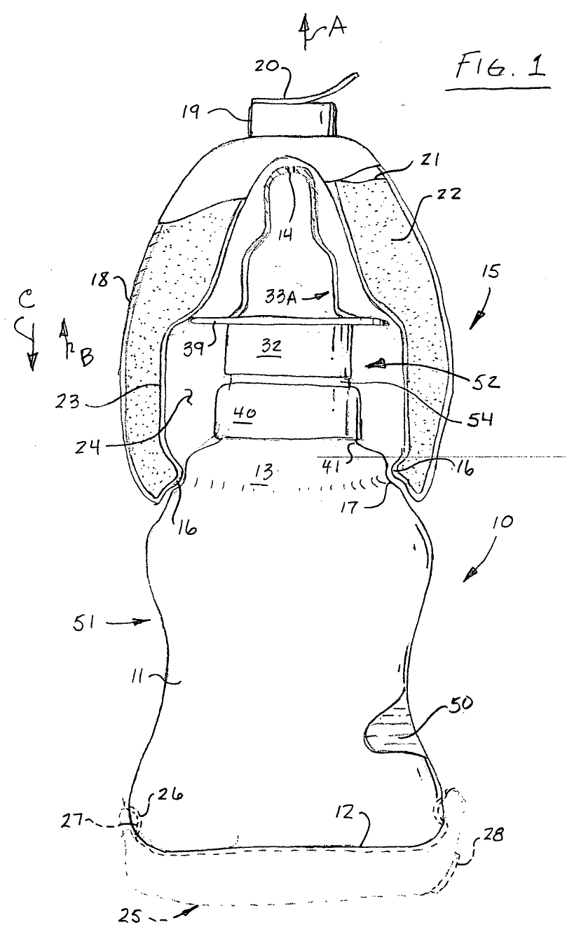

FIG. 1 is side, partial section, elevation view illustrating an apparatus constructed in accordance with the invention for preparing and administering a liquid or other composition to a baby;

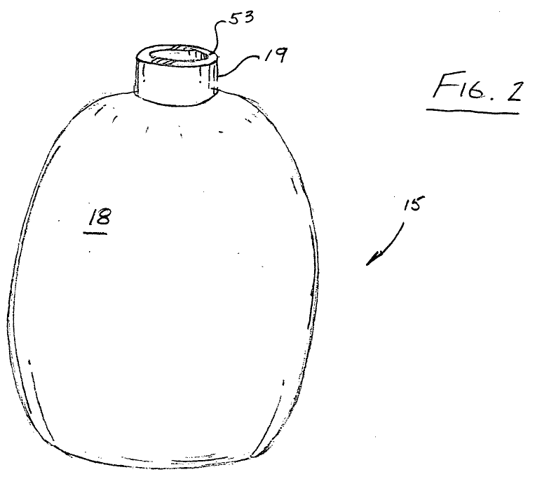

FIG. 2 is a perspective view further illustrating the hollow dust cover utilized in the practice of the invention;

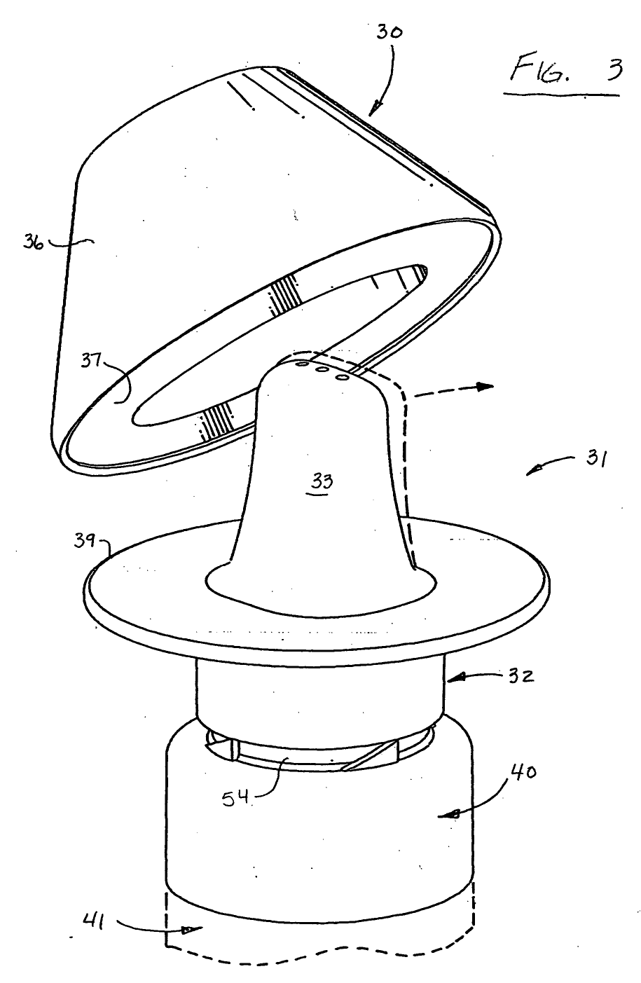

FIG. 3 is a perspective view illustrating an alternate embodiment of the invention;

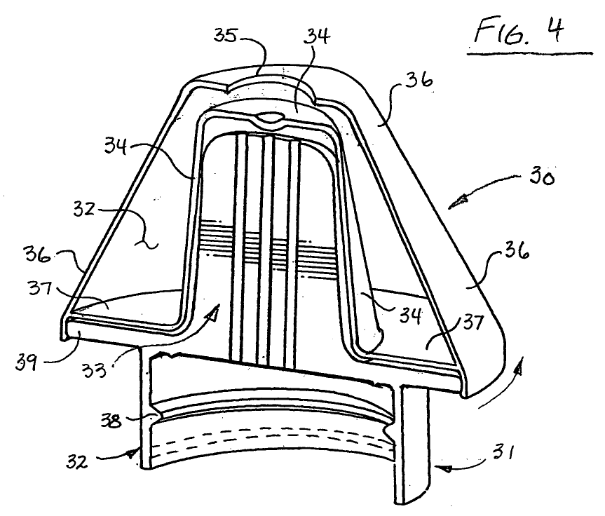

FIG. 4 is a perspective section view of a portion of the apparatus of FIG. 3 illustrating further construction details thereof.

Briefly, in accordance with the invention, I provide improved apparatus for administering a liquid to a baby or child. The apparatus comprises a bottle charged with an aqueous composition and including a top; a dispensing apparatus removably mounted on the top of the bottle to permit a baby or child to engage said apparatus to permit liquid to flow from said bottle into the mouth of the baby or child; a hollow dust cover including a mouth and removably mounted over the dispensing apparatus and charged with powder, the mouth permitting the powder to be poured from the dust cover into the top of the bottle.

In accordance with another embodiment of the invention, I provide a method for administering a liquid to a baby or child. The method includes the steps of providing apparatus comprising a bottle charged with an aqueous composition and including a top; a dispensing apparatus removably mounted on the top of the bottle to permit a baby or child to engage the apparatus to permit liquid to flow from the bottle into the mouth of the baby or child; a hollow dust cover including a mouth and removably mounted over the dispensing apparatus and charged with powder. The mouth permits the powder to be poured from the dust cover into the top of the bottle. The method also includes the steps of removing the dust cover from the dispensing apparatus; removing the dispensing apparatus from the bottle; pouring the powder from the dust cover into the bottle; admixing the powder and the aqueous composition to produce a food composition; mounting the dispensing apparatus on the top of the bottle; and, using the dispensing apparatus to administer the food composition to the baby or child.

Turning now to the drawings, which illustrate the presently preferred embodiments of the invention for the purpose of illustrating the use and practice thereof, and not by way of limitation of the scope of the invention, and in which like reference characters refer to corresponding components throughout the several views, FIG. 1 illustrates apparatus for administering a liquid, slurry, or other desired composition to a baby, child, or other individual or animal. The apparatus is generally indicated by reference character 10 and includes bottle 51, includes dispensing apparatus 52 including hollow, cylindrical, internally threaded base 40 removably turned onto the externally threaded neck 41 at the top 13 of bottle 51, and includes hollow, generally conical, dust cover 15 removably mounted at the top of bottle 13. Bottle 51 is charged with water 50 or any other desired liquid, slurry, or other composition.

The bottom of dust cover 15 includes upstanding cylindrical lip 16 extending around the interior wall 23 of cover 15. Lip 16 is shaped and dimensioned to extend into and removably engage cylindrical detent 17 extending around the top 13 of bottle 51. Cover 15 is removed from bottle 51 by upwardly pulling and displacing cover 15 in the direction of arrow A such that lip 16 slides or pops out of engagement with detent 17. Cover 15, bottle 51, and dispensing apparatus 52 can be shaped and dimensioned in any desired manner. By way of example, and not limitation, cover 15 can be shaped to be removably mounted on and removably engage either or both of bottle 51 and apparatus 52. If cover 15 removably engages apparatus 52 and not bottle 51, cover 15 is still considered herein to be removably mounted on or at bottle 51.

Cover 15 includes outer wall 18, neck 19, mouth 53 (FIG. 2), and removable seal 20 covering mouth 19. Walls 18 and 23 circumscribe, enclose, and define an inner hollow space in cover 15 that received powder 22 or a liquid, or slurry, or other desired composition. The top of powder 22 is indicated in FIG. 1 by reference character 21.

When dust cover 15 is mounted on bottle 51 in the manner illustrated in FIG. 1, cover 15 sealingly encloses dispensing apparatus 52 and circumscribes an open space 24 that extends intermediate wall 23 and apparatus 52.

Apparatus 52 includes hollow pliable nipple 33A mounted on base 39. The diameter, or width, of base 39 is sufficient to prevent, at least in most cases, a baby from getting his or mouth over base 29. Base 39 is mounted on internally threaded hollow cylindrical member 32. Member 32 turns on to externally threaded member 54 such that (1) turning member 32 in a first direction causes member 32 and nipple 33A to simultaneously move in the direction of arrow B to an open position in which liquid in bottle 51 will flow through base 40 and member 32 into nipple 33A to exit out through opening(s) 14 into the mouth of a baby, and (2) in a second direction opposite the first direction cause member 32 and nipple 33A to simultaneously move in the direction of arrow C to a closed position in which liquid in bottle 51 will not flow through base 40 and member 32 into nipple 33A. This type of structure of member 32 and member 54 is well known in the art and is used in “sport caps” or “pop-up caps” used on bottled water. Alternatively member 32 and member 54 can be constructed such that open and closed positions are achieved by simply pulling member 32 straight up or straight down, as the case may be. Consequently, such constructions are well known, are incorporated herein by reference, and are not extensively described herein. Although, the presently preferred structure of base 40 and members 32 and 54 is illustrated in more detail in the embodiment of the invention described in FIGS. 3 and 4.

In use, cover 15 is removed from apparatus 52. Base 40 is unthreaded from the neck 41 of bottle 51. Seal 20 is removed from cover 15. Cover 15 is inverted from the position of FIG. 1 such that powder 22 passes from inside cover 15, through mouth 53, and through the open neck 41 of bottle 51 into water 50 in bottle 51. Base 40 is turned back onto neck 41. Member 32 is in the closed position such that water can not escape from bottle 51 through base 40. Bottle 51 is shaken to admix sufficiently the water 50 and powder 22 to produce a formula or other ingestible composition. Member 32 is moved to the open position so that liquid can flow through base 40 and member 32 into nipple 33A to be dispensed outwardly through aperture 14. The bottle is administered to a baby, either by holding the bottle for the baby or permitting the baby, if able, to hold the bottle so the baby can suckled with its mouth on nipple 33A and draw liquid from inside nipple 33A and out through opening 14 into the baby's mouth.

FIGS. 3 and 4 illustrate another embodiment of the invention including a hollow dust cover 30. cover 30 includes outer conical wall 36 and includes an inner, hollow, generally open ended cylindrical wall 34 shaped to cover nipple 33 in the manner illustrated in FIG. 4. Walls 34 and 36 upwardly depend from base 37. Base 37 extends between and interconnects walls 34 and 36. Wall 36 extends upwardly from base 37 to an aperture 35 formed in the top of wall 36. Aperture 35 is normally covered, or sealed, by a seal (not shown) that, like seal 20, extends over aperture 35 and that has peripheral portions that removably stick to portions of wall 36 adjacent aperture 35. Any desired removable or openable sealing mechanism can be used to seal aperture 35. Beverage powder or other food or pharmaceutical compositions are stored inside cover 30 in a space 32 that extends between walls 34, 36 and base 37.

“Sport cap” or “pop-up” cap 31 includes nipple 33 connected to a circular collar 39 having an outer circular peripheral edge. Collar 39 is connected to internally threaded 38 base 32. Base 32 turns onto externally threaded (not visible) “pop-top” base 40. Base 40 is internally threaded and, as shown in FIG. 3, turns on to the externally threaded top 41 of a bottle. Turning cap 31 up and down on base 40 functions to open and close cap 31 in conventional fashion. As earlier noted, one type of conventional pop-up water bottle cap 31 is opened and closed by rotating the cap 31. This is the kind of cap illustrated in FIGS. 3 and 4. Another kind of conventional pop-up water bottle cap is simply pulled out or pushed in so that the cap is opened or closed, as the case may be. As would be appreciated by those of skill in the art, either kind of “pop-top” cap, or even some other kind of cap that can be opened and closed or that remains continually opened once opened, can be provided with a nipple 33 of desired shape and dimension and construction and with an appropriately shaped dust cap 30 to meet the desired functions of the invention.

In use of the apparatus of FIGS. 3 and 4, base 40 is unthreaded from the neck 41 of the bottle. Water or another fluid is already in, or can be added to, the bottle. The seal (not shown) covering aperture 35 is removed (or is punctured) by peeling the seal off dust cover 30. Dust cover 30 is inverted over the open neck of the bottle such that cover 30 functions as a funnel and powder in cover 30 travels downwardly out opening 35, through the neck 41, and into the bottle. After the powder travels from cover 30 into the bottle 51, base 40 is threaded back on to neck 41 with cap 31 in the closed position. The bottle 51 is shaken to dissolve or disperse satisfactorily the powder in the water in the bottle. Cap 31 is turned or unthreaded to open the cap, and the bottle is given to a baby or child so the baby of child can suck on nipple 33 and remove fluid from the bottle. Dust cover 30 can still, if desired, be utilized to protect nipple 33 in the manner illustrated in FIG. 3. In FIG. 3, dust cover 30 is snapped onto the peripheral edge of collar 39.

Powder or other compositions need not be stored only in a dust cover 15, 30. As illustrated in FIG. 1, powder can be stored in a hollow container 25 that includes an upraised lip 27 that removably snaps into a detent 26 that circumscribes the bottom 12 of bottle 51. container 25 includes a sealed mouth 28 through which powder can (when the mouth is unsealed or opened) be poured into a bottle 51.

Having described my invention in such terms as to enable those skilled in the art to understand and practice it, and having described the presently preferred embodiments of the invention, I claim:

1. Apparatus for administering a liquid to a baby or child, said apparatus comprising
(a) a bottle charged with an aqueous composition and including a top;
(b) a dispensing apparatus removably mounted on said top of said bottle to permit a baby or child to engage said apparatus to permit liquid to flow from said bottle into the mouth of the baby or child;
(c) a hollow dust cover including a mouth and removably mounted over said dispensing apparatus and charged with powder, said mouth permitting said powder to be poured from said dust cover into said top of said bottle.

2. A method for administering a liquid to a baby or child, said method including the steps of
(a) providing apparatus comprising
(i) a bottle charged with an aqueous composition and including a top,
(ii) a dispensing apparatus removably mounted on said top of said bottle to permit a baby or child to engage said apparatus to permit liquid to flow from said bottle into the mouth of the baby or child,
(iii) a hollow dust cover including a mouth and removably mounted over said dispensing apparatus and charged with powder, said mouth permitting said powder to be poured from said dust cover into said top of said bottle;
(b) removing said dust cover from said dispensing apparatus;
(c) removing said dispensing apparatus from said bottle;
(d) pouring said powder from said dust cover into said bottle;
(e) admixing said powder and said aqueous composition to produce a food composition;
(f) mounting said dispensing apparatus on said top of said bottle; and,
(g) using said dispensing apparatus to administer said food composition to the baby or child.
